(19) United States
(12) Patent Application Publication
(10) Pub. No.: US 2009/0039210 A1
(43) Pub. Date: Feb. 12, 2009

(54) CPAP Hose Support System

(76) Inventors: Steven T. Yates, Sacramento, CA (US); Deepak K. Shrivastava, Stockton, CA (US)

Correspondence Address: NEUSTEL LAW OFFICES, LTD., 2534 SOUTH UNIVERSITY DRIVE, SUITE 4, FARGO, ND, 58103, US

(21) Appl. No.: 12/035,466

(22) Filed: Feb. 22, 2008

Related U.S. Application Data
(60) Provisional application No. 60/955,061, filed on Aug. 10, 2007.

(51) Int. Cl. F16L 3/00

(52) U.S. Cl. 248/74.1; 128/204.18; 248/80

(57) ABSTRACT

A CPAP tubing support system for reducing user contact with the CPAP tubing of a CPAP machine. The CPAP tubing support system generally includes a base, a vertical member attached to the base, a horizontal member extending from an upper end of the vertical member, and a support member attached to a distal end of the horizontal member for receiving a length of CPAP tubing from a CPAP machine. The support member includes a slot and a receiver opening for receiving the CPAP tubing. The support member preferably is comprised of a substantially circular shape for engaging the ribs of the CPAP tubing in a relatively non-moving manner while still allowing the CPAP tubing to extend or retract when the user is active in bed. The vertical member is preferably rotatably connected to the base.

### CROSS REFERENCE TO RELATED APPLICATIONS

I hereby claim benefit under Title 35, United States Code, Section 119(e) of U.S. provisional patent application Ser. No. 60/955,061 filed Aug. 10, 2007. The 60/955,061 application is currently pending. The 60/955,061 application is hereby incorporated by reference into this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to continuous positive airway pressure (“CPAP”) machines and more specifically it relates to a CPAP tubing support system for reducing user contact with the CPAP tubing of a CPAP machine.

2. Description of the Related Art

Any discussion of the related art throughout the specification should in no way be considered as an admission that such related art is widely known or forms part of common general knowledge in the field.

Sleep apnea occurs when the upper airway becomes narrow as the muscles relax naturally during sleep thereby reducing airflow and oxygen to the lungs. The reduced oxygen to the lungs results in a reduction of oxygen in the blood thereby causing arousal from sleep.

Continuous positive airway pressure (“CPAP”) machines are used for patients suffering from sleep apnea. CPAP machines reduce sleep apnea by delivering a stream of air to the user's airway expanding the upper airway so that unobstructed breathing is possible.

A conventional CPAP machine is comprised of a flow generator (e.g. fan unit), a length of CPAP tubing fluidly connected to the flow generator for delivering pressurized air and an interface (e.g. nasal pillow, nose mask or full-face mask) fluidly connected to the CPAP tubing opposite of the flow generator. In use, the CPAP machine is positioned adjacent to the bed of the user (e.g. on a dresser) and the CPAP tubing is allowed to simply rest upon the surface of the bed and the CPAP user as the interface is fluidly connected to the air passage of the user.

One of the main problems with conventional CPAP machines is that the CPAP tubing can cause irritation or arousal to the user during sleep resulting in discomfort. Another problem is that the CPAP tubing may be pulled by the user during their sleep which can move the flow generator resulting in potential damage from dropping on the floor. Another problem is that the pulling upon the CPAP tubing can result in dislodging of the interface from the user's face thereby reducing the effectiveness of the CPAP machine.

Because of the inherent problems with the related art, there is a need for a new and improved CPAP tubing support system for reducing user contact with the CPAP tubing of a CPAP machine.

### BRIEF SUMMARY OF THE INVENTION

The general purpose of the present invention is to provide a CPAP tubing support system that has many of the advantages of the accessories for CPAP machines mentioned heretofore. The invention generally relates to a CPAP tubing support for a CPAP machine which includes a base, a vertical member attached to the base, a horizontal member extending from an upper end of the vertical member, and a support member attached to a distal end of the horizontal member for receiving a length of CPAP tubing from a CPAP machine. The support member includes a slot and a receiver opening for receiving the CPAP tubing. The support member preferably is comprised of a substantially circular shape for engaging the ribs of the CPAP tubing in a relatively non-moving manner. The vertical member is preferably rotatably connected to the base.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

An object is to provide a CPAP tubing support system for reducing user contact with the CPAP tubing of a CPAP machine.

Another object is to provide a CPAP tubing support system that reduces arousal and irritation of a user while sleeping.

An additional object is to provide a CPAP tubing support system that reduces pulling upon the CPAP tubing by the user while sleeping.

A further object is to provide a CPAP tubing support system that allows the CPAP tubing to extend, remain stationary or retract as needed.

An additional object is to provide a CPAP tubing support system that follows the motion of the user while they are sleeping.

Another object is to provide a CPAP tubing support system that retains the CPAP tubing and interface adjacent to the CPAP machine during non-use without having to hang the CPAP tubing and interface.

Another object is to provide a CPAP tubing support system that may be attached to a wall, headboard or other surfaces surrounding a user's bed.

Another object is to provide a CPAP tubing support system that may be easily disassembled and attached to a bed while traveling.

A further object is to provide a CPAP tubing support system that maintains the CPAP tubing in a substantially constant position by engaging the ridges of the CPAP tubing.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention attached to a bed and supporting a CPAP tubing with the interface attached to a face of a user.

FIG. 2 is an upper perspective view of the present invention attached to a bed and supporting a CPAP tubing with the interface positioned adjacent to the support portion for storage.

FIG. 3a is an upper perspective view of the present invention.

FIG. 3b is an upper perspective view of the present invention illustrating the range of movement.

FIG. 4 is an exploded upper perspective view of the present invention.

FIG. 5 is a side view of the present invention attached to a wall.

FIG. 6 is a front view of the present invention.

FIG. 7 is an upper perspective view of a preferred embodiment that is portable.

FIG. 8 is an exploded upper perspective view of the preferred portable embodiment.

FIG. 9 is a side view of the preferred embodiment with the portable base positioned beneath the mattress of the bed.

FIG. 10 is an upper perspective view of a counterweight.

FIG. 11 is an upper perspective view of an preferred embodiment for the portable base comprised of a solid structure.

### DETAILED DESCRIPTION OF THE INVENTION

### A. Overview.

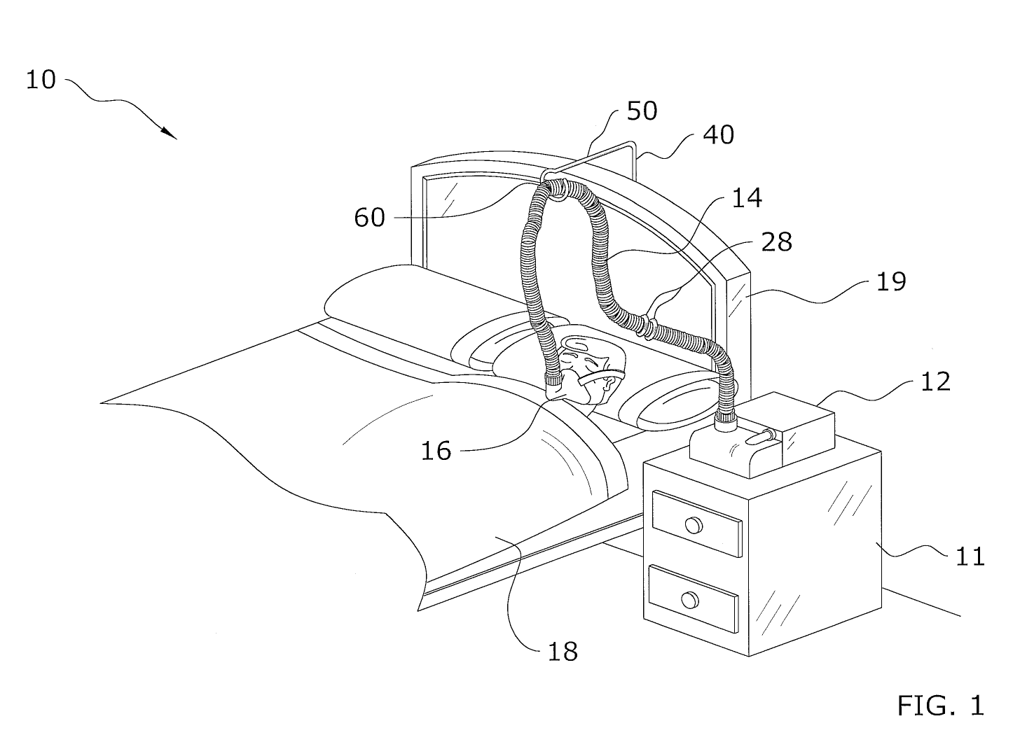

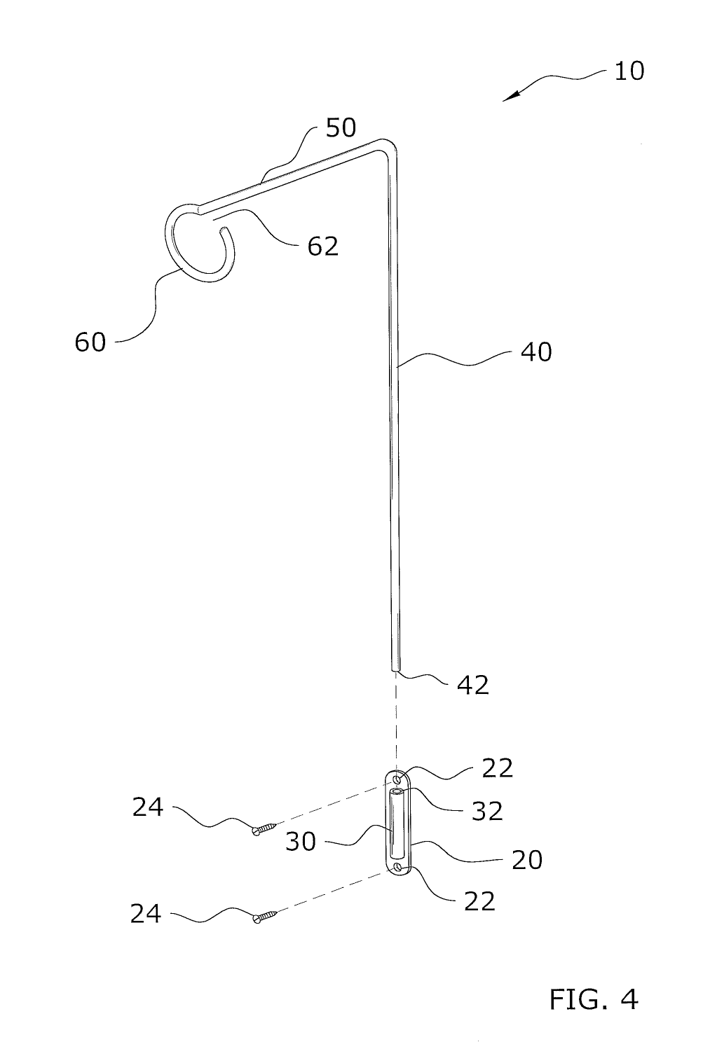

Turning now descriptively to the drawings, in which similar reference characters denote similar elements throughout the several views, FIGS. 1 through 11 illustrate a CPAP tubing support system 10, which comprises a base, a vertical member 40 attached to the base, a horizontal member extending from an upper end of the vertical member 40, and a support member 60 attached to a distal end of the horizontal member for receiving a CPAP tubing 14 from a CPAP machine. The support member 60 may include a slot 62 and a receiver opening 64 for receiving the CPAP tubing 14. The support member 60 preferably is comprised of a substantially circular shape for engaging the ribs of the CPAP tubing 14 in a relatively non-moving manner. The vertical member 40 is preferably rotatably connected to the base.

### B. CPAP Machine.

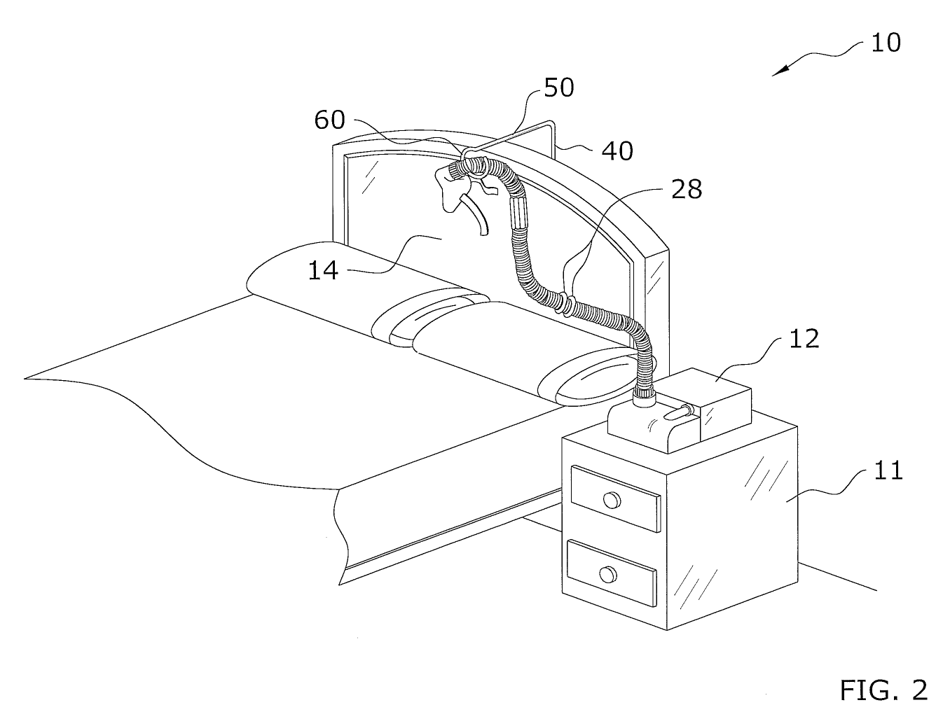

FIGS. 1 and 2 illustrate a conventional CPAP machine. A conventional CPAP machine includes an interface 16 (e.g. nasal pillow, nose mask or full-face mask), a CPAP tubing 14 fluidly connected to the interface 16 and a flow generator 12 (e.g. fan unit) fluidly connected to the CPAP tubing 14 opposite of the interface 16.

The CPAP tubing 14 can range from 1.5 feet to 10+ feet in length. The CPAP tubing 14 is comprised of a flexible tubing structure that typically has a smooth interior and a helical ribbed 18 exterior that prevents collapsing of the CPAP tubing 14. The CPAP tubing 14 has various exterior diameters (e.g. ⅛ of an inch, ⅞ of an inch) and the support member 60 is formed for receiving most exterior diameters of CPAP tubing 14.

The flow generator 12 generates a pressurized flow of air that is delivered through the length of CPAP tubing 14 to the interface 16. The flow generator 12 is positioned upon a dresser 11 or other close object. The interface 16 is connected to the face of the user and delivers the pressurized air to the air passage of the user to keep the upper air passage open as shown in FIG. 1. Various other types of CPAP machines may be utilized with the present invention other than the CPAP machine illustrated in FIGS. 1 and 2 of the drawings.

### C. Base.

### 1. Stationary Base.

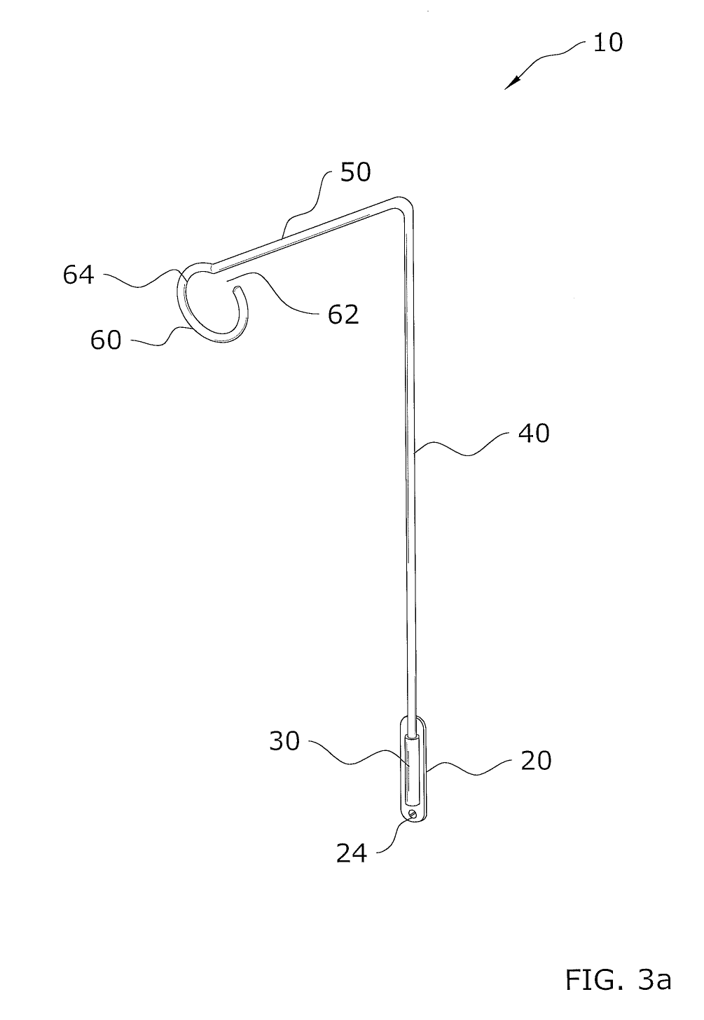

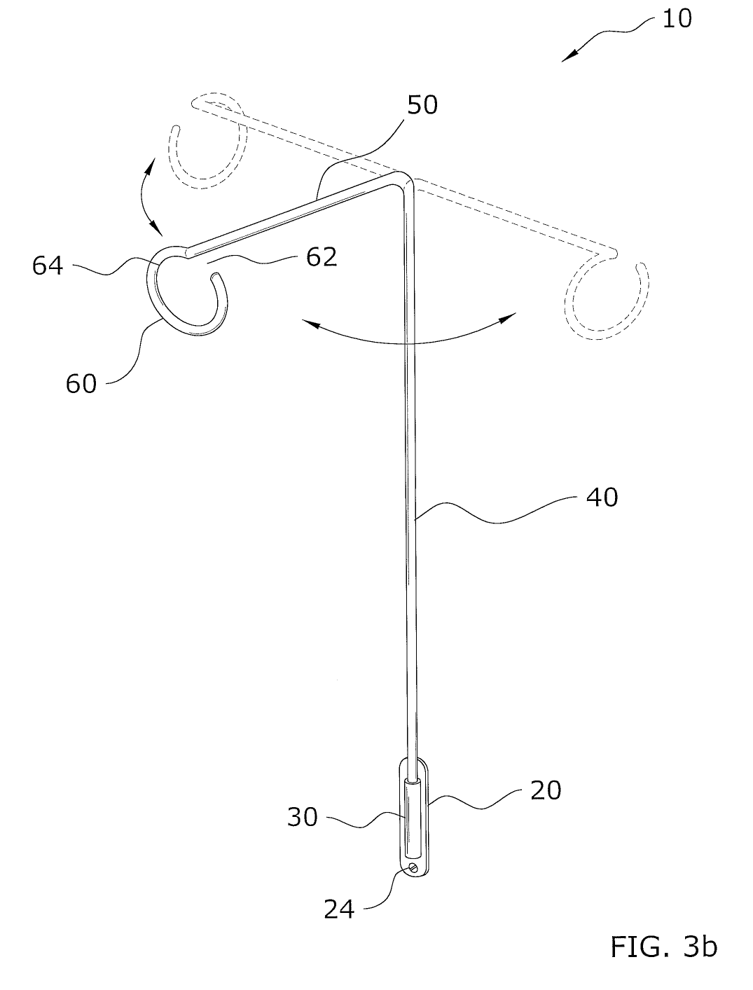

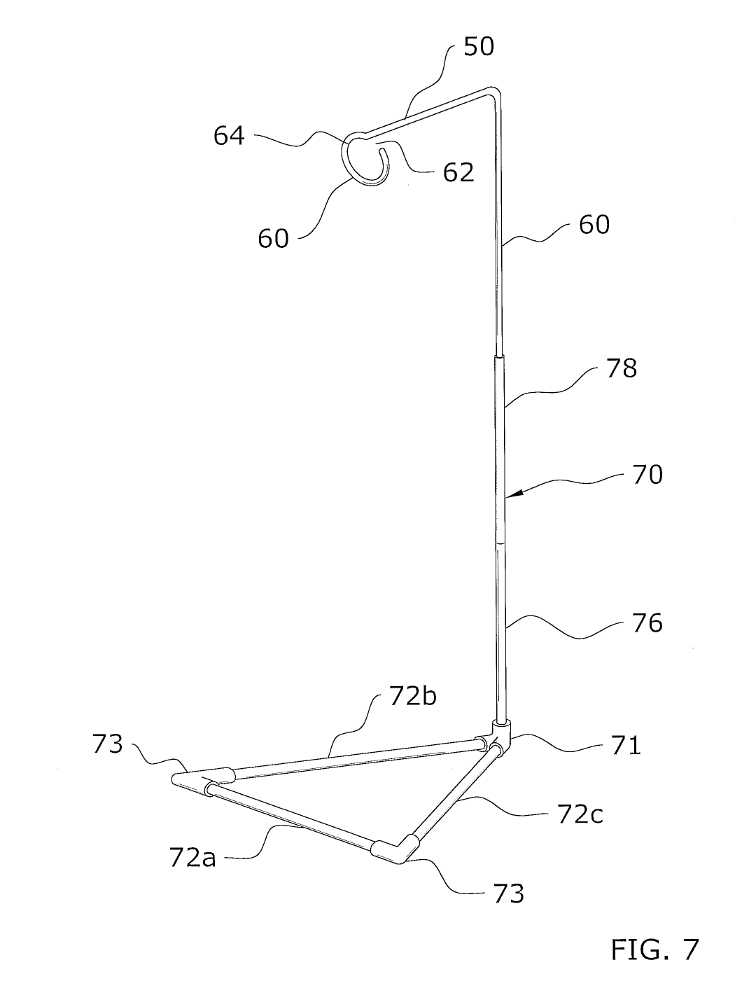

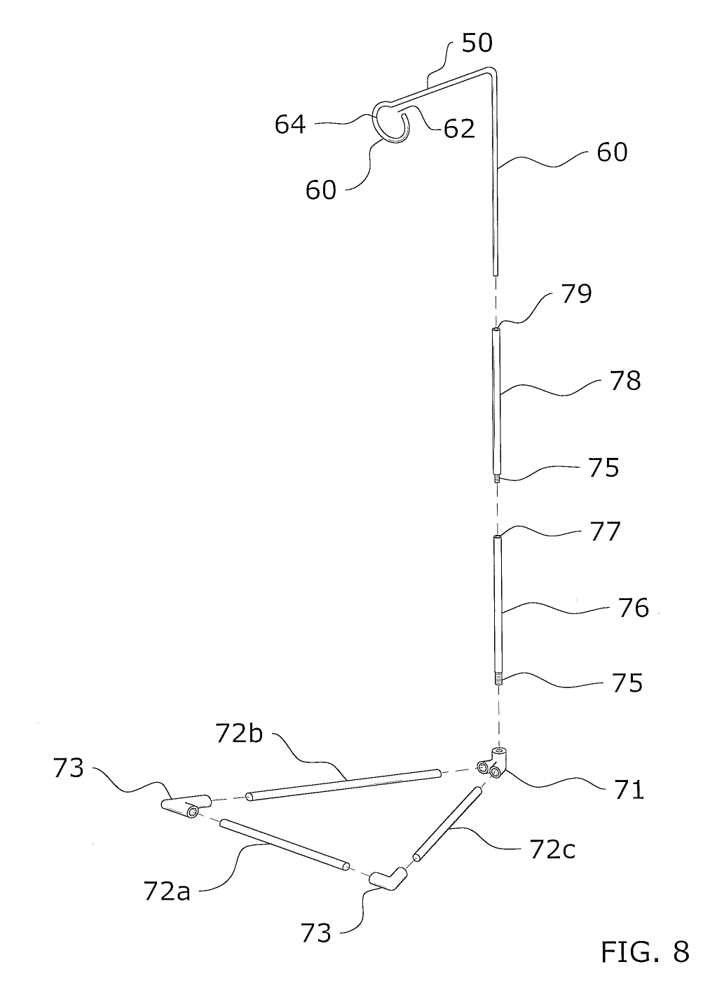

FIGS. 3a through 6 illustrate an attachment base 20 for mounting to a wall 13, headboard 19 or similar structure by a bed 18. FIGS. 7 through 8 illustrate an preferred permanent or portable base 70 that may be utilized by a user when traveling which is discussed below.

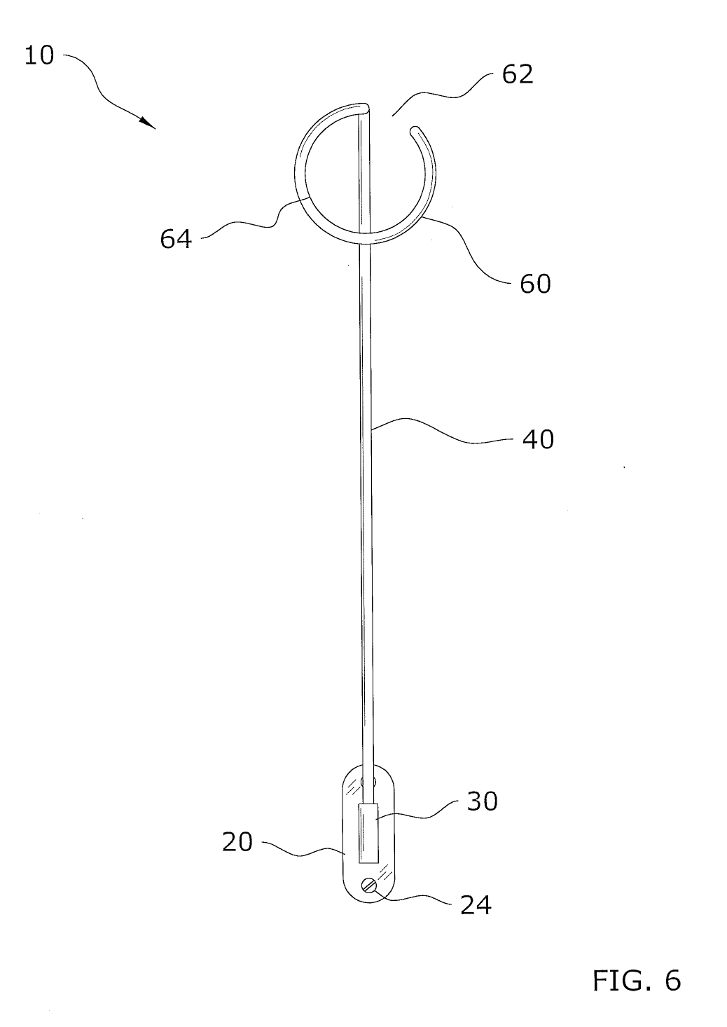

The preferred base is preferably comprised of an attachment base 20, a plurality of apertures 22 within the attachment base 20, a plurality of fasteners 24 (e.g. nails, screws) extending through the plurality of apertures 22, and a receiver member 30 attached to the attachment base 20. The receiver member 30 is preferably comprised of a tubular structure that extends in a substantially vertical manner as best illustrated in FIG. 6 of the drawings. The receiver member 30 includes an upper opening 32 for rotatably receiving the lower end 42 of the arm structure.

### 2. Portable Base.

FIGS. 7 and 8 illustrate a preferred portable base 70 for use when a user is traveling instead of the attachment base 20. The portable base 70 includes a first support 76 having a telescoping slip fit female end 77 and a lower telescoping slip fit male end 75. It can be appreciated that threaded connecting ends may be utilized within the present invention. The portable base 70 further includes a second support 78 having an upper receiver opening 79 and a lower telescoping slip fit male end 75 that is threadably secured to the upper telescoping slip fit female end 77. The upper receiver opening 79 rotatably receives the lower end 42 of the arm structure as illustrated in FIG. 7 of the drawings.

A corner member 71 preferably receives the lower male end 75 of the first support 76 as shown in FIG. 8 of the drawings. A plurality of lower members 72 extend from the corner member 71 substantially transverse with respect to the first support 76 forming a substantially triangular shape. A plurality of connecting members 73 are connected to distal portions of the plurality of lower member and an end lower member extends between the plurality of connecting members 73 forming a substantially triangular shape. The connecting members 73 and end lower member preferably at connected frictionally within openings within the corner member 71 and the connecting members 73 as illustrated in FIG. 8 of the drawings.

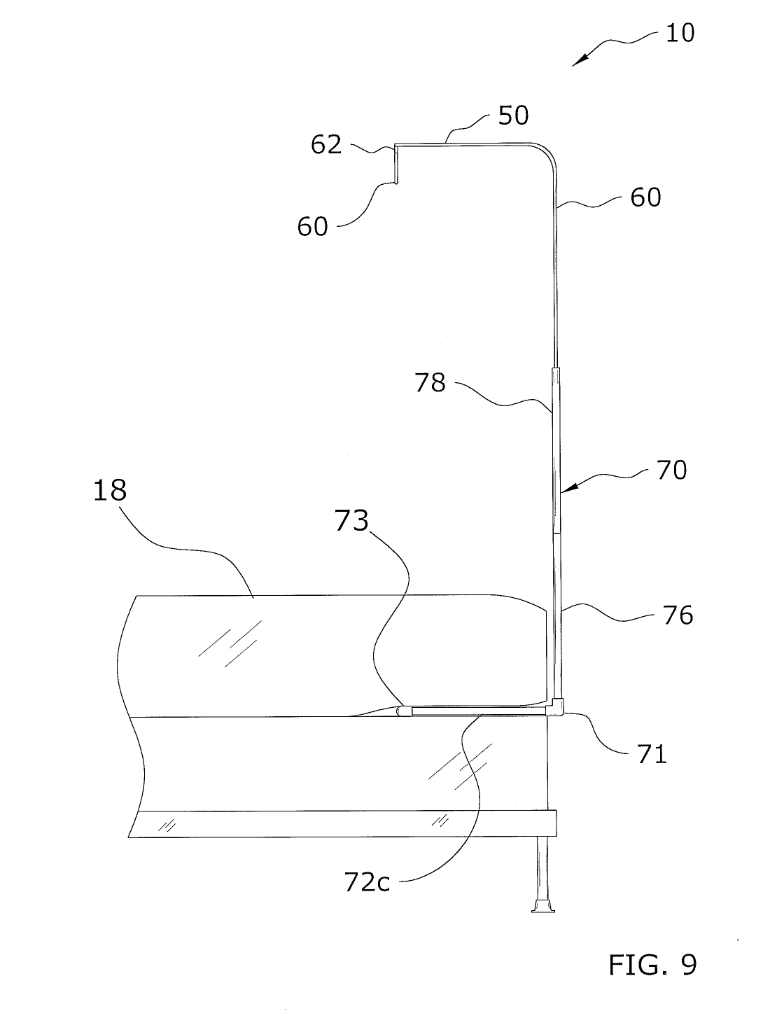

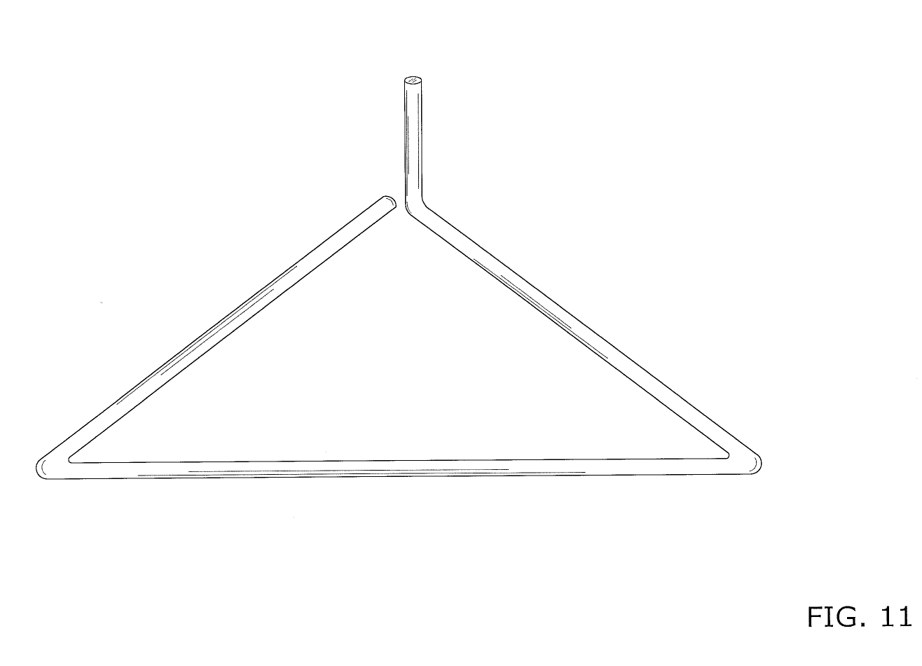

When assembled, the lower portion of the portable base 70 is positioned between the mattress and the box spring of a bed 18 as illustrated in FIG. 9 of the drawings. The portable base 70 is retained in position by the weight of the mattress thereby eliminating the requirement for fasteners 24 or other types of attachment devices. The arm structure is attached to the portable base 70 and used to support the CPAP tubing 14 of the CPAP machine. When finished, the portable base 70 is disassembled and stored in a convenient storage location (e.g. bag). FIG. 11 is an upper perspective view of an alternative embodiment for the portable base 70 comprised of a solid triangular structure without any removable components.

Alternatively, the ends of the portable base 70 may be comprised of a swaged structure for fitting together in a frictional manner. Various other attachment means may be utilized to connect the components of the portable base 70 together.

### D. Arm Structure.

FIGS. 3a through 9 illustrate the arm structure for supporting the support member 60 in an upright position. The arm structure includes a lower end 42 rotatably attached to the base and extends upwardly from the base. The arm structure is preferably comprised of a rigid structure for supporting the CPAP tubing 14 and is preferably coated with a resilient material (e.g. power coated paint, rubber coating).

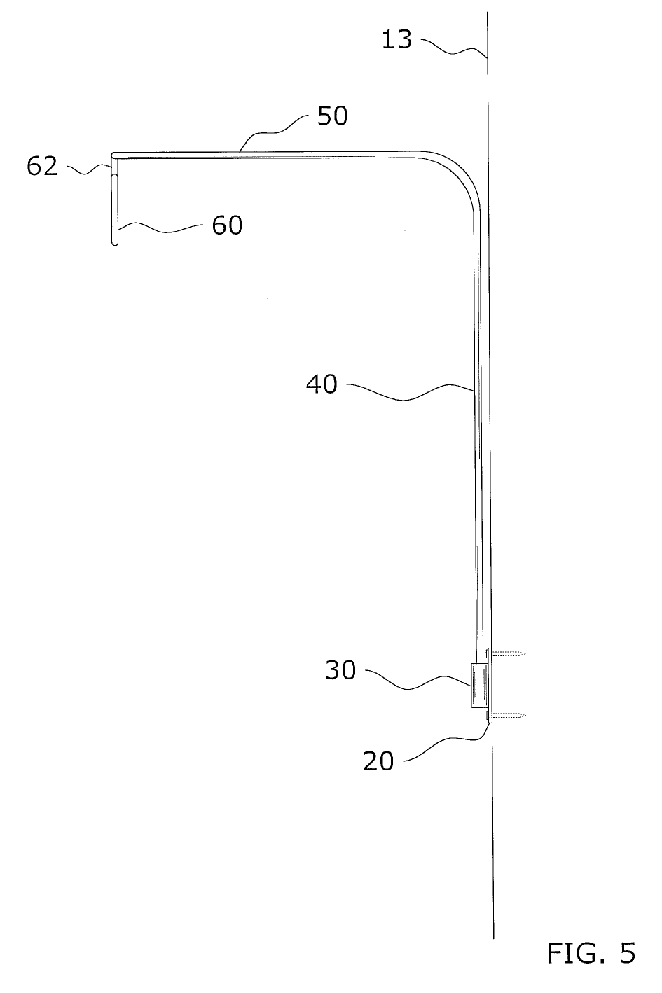

The arm structure is preferably comprised of a vertical member 40 having a lower end 42 and an upper member 50 extending from an upper end of the vertical member 40 as illustrated in FIGS. 3a through 5 of the drawings. The lower end 42 is rotatably positioned within the base to allow for rotation of the arm structure as the user moves the CPAP tubing 14. The upper member 50 preferably extends in a substantially horizontal direction from the vertical member 40 at a substantially ninety-degree angle with respect to the vertical member 40 as best illustrated in FIG. 5 of the drawings. The corner between the upper member 50 and the vertical member 40 is preferably curved as illustrated in FIG. 5 of the drawings.

### E. Support Member.

The support member 60 is attached to the arm structure for receiving the CPAP tubing 14 from the CPAP machine. A receiver opening 64 may extend through the support member 60 for potentially receiving the CPAP tubing 14 from the CPAP machine. The receiver opening 64 may be sized larger than the CPAP tubing 14 as illustrated in FIGS. 1 and 2 of the drawings. In particular, the receiver opening 64 may be larger than 1 inch in diameter.

As best illustrated in FIGS. 3a, 3b and 6 of the drawings, a slot 62 extends into the support member 60 into the receiver opening 64 for allowing the CPAP tubing 14 to be inserted and removed within the support member 60. The slot 62 has a width sufficient to allow oxygen hoses but not wide enough to allow the CPAP tubing 14 to pass through (e.g. 0.25 inches).

The support member 60 is preferably comprised of a ring structure having a circular shape as best illustrated in FIG. 6 of the drawings. The support member 60 preferably extends downwardly from the distal end of the upper member 50 to prevent interference with the CPAP tubing 14 by the upper member 50. The receiver opening 64 has a substantially curved lower portion for engaging at least one rib of the CPAP tubing 14. The receiver opening 64 is comprised of a circular shape.

### F. Counterweight.

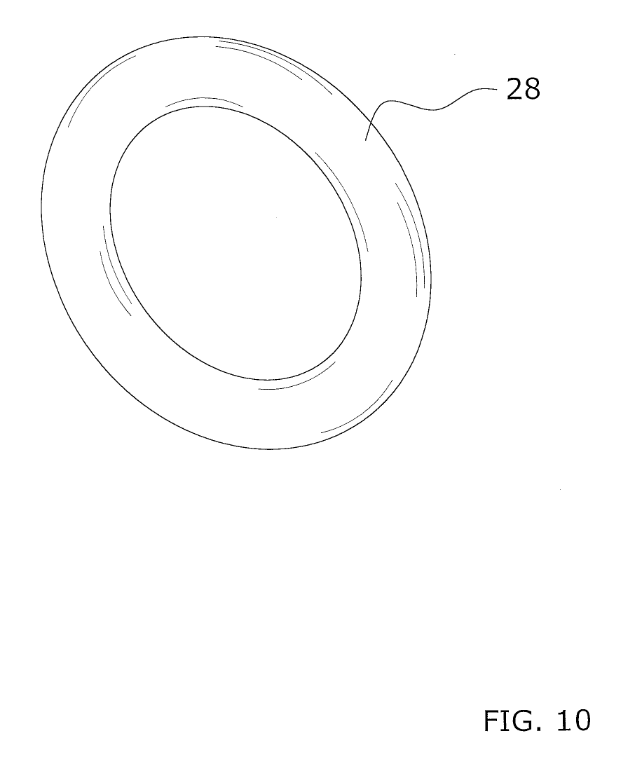

One or more counterweights 28 are preferably attached to the length of the CPAP tubing 14 as best illustrated in FIGS. 1 and 2 of the drawings. The counterweights 28 are comprised of a heavier material (e.g. metal) and preferably have a circular ring structure that preferably loosely fits about the exterior of the CPAP tubing 14 as illustrated in FIG. 10 of the drawings. The counterweights 28 preferably are secured within a recessed groove within the helical ribbing on the CPAP tubing 14.

The counterweights 28 are preferably positioned upon the CPAP tubing 14 between the support member 60 and the CPAP machine to counterbalance the weight of the CPAP tubing 14 that extends through the support member 60. The counterweights 28 assist in the retraction of the CPAP tubing 14 for storage as illustrated in FIG. 2 of the drawings. The counterweights 28 further assist in maintaining the CPAP tubing 14 from freely moving through the support member 60. The counterweights 28 may be added to the CPAP tubing 14 as desired by the user to achieve a desired weight balance for the CPAP tubing 14 with respect to the support member 60.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims (and their equivalents) in which all terms are meant in their broadest reasonable sense unless otherwise indicated. Any headings utilized within the description are for convenience only and have no legal or limiting effect.

We claim:

1. A CPAP tubing support system, comprising:
a base;
an arm structure having a lower end rotatably attached to said base and extending upwardly from said base;
a support member attached to said arm structure for receiving a CPAP tubing from a CPAP machine;
a receiver opening extending through said support member for receiving the CPAP tubing from the CPAP machine; and
a slot extending into said support member into said receiver opening.

2. The CPAP tubing support system of claim 1, wherein said support member is comprised of a ring structure.

3. The CPAP tubing support system of claim 1, wherein said support member is comprised of a circular shape.

4. The CPAP tubing support system of claim 1, wherein said receiver opening has a substantially curved lower portion for engaging at least one rib of the CPAP tubing.

5. The CPAP tubing support system of claim 1, wherein said receiver opening is comprised of a circular shape.

6. The CPAP tubing support system of claim 1, wherein said arm structure is comprised of a vertical member having a lower end and an upper member extending from an upper end of said vertical member, wherein said lower end is rotatably positioned within said base.

7. The CPAP tubing support system of claim 6, wherein said upper member extends in a substantially horizontal direction from said vertical member.

8. The CPAP tubing support system of claim 7, wherein said upper member extends at a substantially ninety-degree angle from said vertical member.

9. The CPAP tubing support system of claim 1, wherein said base is comprised of an attachment base, a plurality of apertures within said attachment base, a plurality of fasteners extending through said plurality of apertures, and a receiver member attached to said attachment base in a substantially vertical manner, wherein said receiver member includes an upper opening for rotatably receiving said lower end of said arm structure.

10. The CPAP tubing support system of claim 1, wherein said base is comprised of a plurality of connecting members having an upper receiver opening that rotatably receives said lower end of said arm structure, and a lower base extending horizontally from a second lower end of said plurality of connecting members.

11. A CPAP tubing support system, comprising:
a CPAP machine including an interface, a CPAP tubing fluidly connected to said interface and a flow generator fluidly connected to said CPAP tubing opposite of said interface;
a base;
an arm structure having a lower end rotatably attached to said base and extending upwardly from said base;
a support member attached to said arm structure for receiving said CPAP tubing from said CPAP machine;
a receiver opening extending through said support member for receiving said CPAP tubing from said CPAP machine; and
a slot extending into said support member into said receiver opening.

12. The CPAP tubing support system of claim 11, wherein said support member is comprised of a circular ring structure.

13. The CPAP tubing support system of claim 11, wherein said receiver opening has a substantially curved lower portion for engaging at least one rib of the CPAP tubing.

14. The CPAP tubing support system of claim 11, wherein said receiver opening is comprised of a circular shape.

15. The CPAP tubing support system of claim 11, wherein said arm structure is comprised of a vertical member having a lower end and an upper member extending from an upper end of said vertical member, wherein said lower end is rotatably positioned within said base.

16. The CPAP tubing support system of claim 15, wherein said upper member extends in a substantially horizontal direction from said vertical member in a substantially ninety-degree angle from said vertical member.

17. The CPAP tubing support system of claim 11, wherein said base is comprised of an attachment base, a plurality of apertures within said attachment base, a plurality of fasteners extending through said plurality of apertures, and a receiver member attached to said attachment base in a substantially vertical manner, wherein said receiver member includes an upper opening for rotatably receiving said lower end of said arm structure.

18. The CPAP tubing support system of claim 1, wherein said base is comprised of:
a first support having an upper telescoping slip fit female end and a lower telescoping slip fit male end;
a second support having an upper receiver opening and a lower telescoping slip fit male end that is threadably secured to said upper telescoping slip fit female end, wherein said upper receiver opening rotatably receives said lower end of said arm structure;
a corner member threadably receiving said lower telescoping slip fit male end of said first support;
a plurality of lower members extending from said corner member substantially transverse with respect to said first support;
a plurality of connecting members connected to distal portions of said plurality of lower member; and
an end lower member extending between said plurality of connecting members.

19. The CPAP tubing support system of claim 11, including at least one counterweight attached to said CPAP tubing.

20. A CPAP tubing support system, comprising:
a CPAP machine including an interface, a CPAP tubing fluidly connected to said interface and a flow generator fluidly connected to said CPAP tubing opposite of said interface;
a base;
an arm structure having a lower end rotatably attached to said base and extending upwardly from said base;
wherein said arm structure is comprised of a vertical member having a lower end and an upper member extending from an upper end of said vertical member, wherein said lower end is rotatably positioned within said base;
wherein said upper member extends in a substantially horizontal direction from said vertical member in a substantially ninety-degree angle from said vertical member;
a support member attached to said arm structure for receiving said CPAP tubing from said CPAP machine;
wherein said support member is comprised of a circular ring structure;
a receiver opening extending through said support member for receiving said CPAP tubing from said CPAP machine;
wherein said receiver opening has a substantially curved lower portion for engaging at least one rib of the CPAP tubing;
wherein said receiver opening is comprised of a circular shape;
a slot extending into said support member into said receiver opening; and
at least one counterweight attached to said CPAP tubing between said support member and said flow generator.
